(19) United States
(12) Patent Application Publication
(10) Pub. No.: US 2002/0153773 A1
(43) Pub. Date: Oct. 24, 2002

(54) Track roller

(75) Inventor: Woo-Suk Yoon, Seoul (KR)

Correspondence Address: Frank Chau, F. CHAU & ASSOCIATES, LLP, Suite 501, 1900 Hempstead Turnpike, East Meadow, NY, 11554, US

(73) Assignee: Jinsung T.E.C. Co., Ltd.

(21) Appl. No.: 09/841,641

(22) Filed: Apr. 24, 2001

(51) Int. Cl. B62D 55/14

(52) U.S. Cl. 305/136

(57) ABSTRACT

A track roller is provided, in which a bushing case and a roller body are integrated inside the track roller, to accordingly facilitate an assembly. Also, since a lubricant path is formed in the roller body, a lubrication work is improved. The track roller having a pair of left and right bushings inserted on the central protrusion of the central axis and which is rotatably fixed, includes a bushing case inserted on an outer circumferential surface of one side of the bushing, a roller body provided in the outer circumferential surface of the bushing case and formed in a shape corresponding to the bushing, in which an extension is formed on the other side of the bushing and provided in the outer circumferential surface of the bushing, and a combiner for fixing the bushing case and the roller body so that they are not dismantled from each other. As such, the number of components is reduced to thereby facilitate an assembly and shorten an assembly time, which enhances an economical efficiency. Also, since an inclined lubricant path is provided, an internal lubricant oil is forcedly circulated due to rotation of the roller body. Thus, lubrication is enhanced, which provides a cooling effect for offsetting heat generated from internal heat-generating components.

### BACKGROUND OF THE INVENTION

1. Field of the Invention

The present invention relates to a track roller for an endless track type heavy equipment vehicle and more particularly, to a track roller in which a bushing case and a roller body are integrated, to accordingly facilitate an assembly, and a lubricant path is also formed in the roller body, so that an internal lubricant oil is forcedly circulated during operation of equipment, to thereby provide lubrication and a cooling effect.

2. Description of the Related Art

In general, track rollers for guiding the track to run are provided on the lower portion of a track type heavy equipment vehicle. In such a track roller, a roller body is rotatably fixed to a central axis in most cases. The roller body is fixed in various manners so that the roller body does not secede from the central axis during rotation.

FIG. 1 is a sectional view showing a conventional track roller. As shown in FIG. 1, bushings 20 and 20a are fitted on both sides of a central axis 10 in order to prevent abrasion. Bushing cases 30 and 30a are fitted on the bushings 20 and 20a. Protruding outer edge portions of the bushing cases 30 and 30a are adhered closely to both sides of a roller body 40, and then are engaged with bolts 50 and 50a.

The track roller is provided with a seal 70 which is installed between the roller body 40 and a collar 60, for preventing internal oil from leaking.

The track roller combines the roller body with the central axis using a bolt, which causes a cumbersome assembly. Also, it takes a long assembly time, and the number of components increases, to thereby cause an increase in a production cost. In addition, heat between the components generated during a heavy load and a high speed rotation is not suppressed effectively, to thereby cause oil leakage and reduction in a life cycle.

FIG. 2 is a sectional view showing another conventional track roller. According to the track roller shown in FIG. 2, bushings 20 and 20a are fitted on a central axis 10, and then a pair of left and right bushing cases 30b and 30c. Here, snap rings 80 and 80a at left and right sides are inserted into predetermined portions of the bushing cases 30b and 30c, respectively. The snap rings 80 and 80a are elastically inserted into fitting grooves 41 and 41 a formed at both inner sides, and locked Here, a roller body 40a is combined and fixed to the center of the central axis 10. The above conventional track roller also uses a pair of left and right snap rings 80 and 80a, to thereby cause a cumbersome assembly. Also, the conventional track roller does not suppress overheat and noise effectively, to thereby cause oil leakage and reduction in a life cycle.

As described above, the conventional track rollers increases the number of components necessary for an assembly, to thereby cause much production cost. Also, an assembly is cumbersome and an assembly time is taken long. Heat between the components generated during a heavy load and a high speed rotation is not suppressed effectively, to thereby cause oil leakage and reduction in a life cycle.

### SUMMARY OF THE INVENTION

To solve the above problems, it is an object of the present invention to provide a track roller in which a bushing case and a roller body are integrated, to accordingly facilitate an assembly.

It is another object of the present invention to provide a track roller in which since a lubricant path is formed in the roller body, the lubricant is forcedly circulated to improve lubrication and prevent overheat between components.

To accomplish the above object of the present invention, there is provided a track roller having a pair of left and right bushings inserted on the central protrusion of the central axis and which is rotatably fixed, the track roller comprising: a bushing case inserted on an outer circumferential surface of one side of the bushing; a roller body provided in the outer circumferential surface of the bushing case and formed in a shape corresponding to the bushing, in which an extension is formed on the other side of the bushing and provided in the outer circumferential surface of the bushing; and a combiner for fixing the bushing case and the roller body so that the bushing case and the roller body are not dismantled from each other.

### BRIEF DESCRIPTION OF THE DRAWINGS

The above object and other advantages of the present invention will become more apparent by describing the preferred embodiment thereof in more detail with reference to the accompanying drawings in which:

FIG. 1 is a sectional view showing a conventional track roller;

FIG. 2 is a sectional view showing another conventional track roller; and

FIG. 3 is a sectional view showing a track roller according to the present invention.

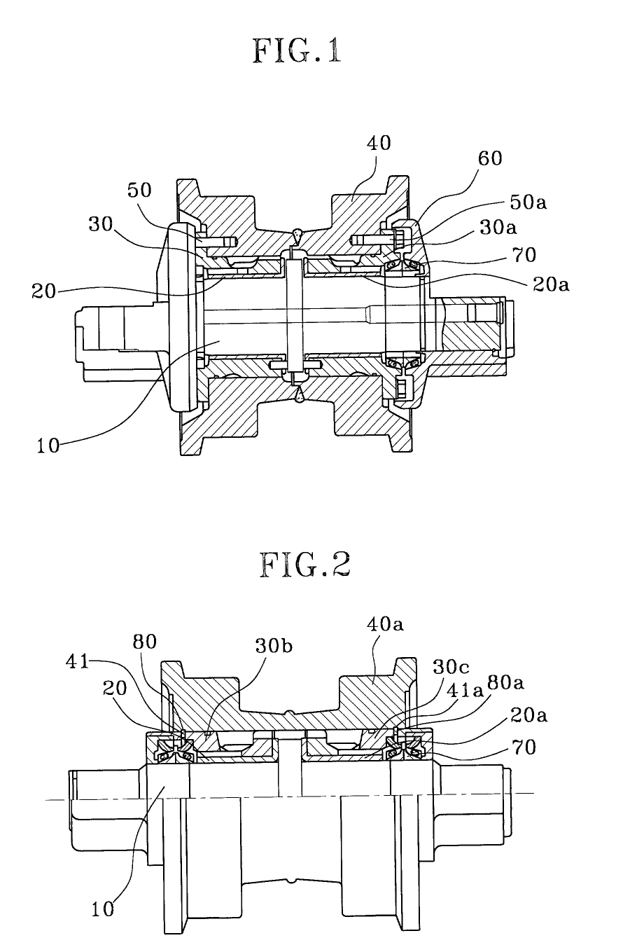

### DETAILED DESCRIPTION OF THE INVENTION

A preferred embodiment of the present invention will be described with reference to the accompanying drawings.

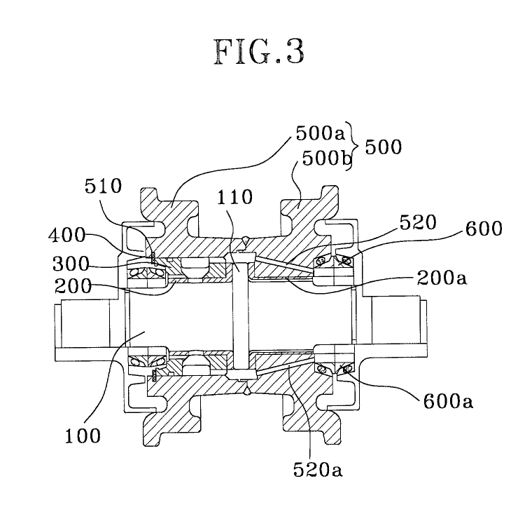

FIG. 3 is a sectional view showing a track roller according to the present invention. As shown in FIG. 3, bushings 200 and 200a are fitted on both sides of a central axis 100 in order to prevent abrasion. A bushing case 300 is fitted on the outer circumferential surface of the left bushing 200. The left side 500a of the roller body 500 is provided on the outer circumferential surface of the bushing case 300, and the right side 500b is provided on the outer circumferential surface of the bushing 200a. The right-hand roller body 500b is formed in a shape that an extension integrated with the bushing case corresponds to the bushing 200a.

A snap ring 400 is fitted onto the outer circumferential surface of the bushing case 300. A fixing groove 510 is formed on the inner circumferential surface of the roller body 500a corresponding to the bushing case 300, The snap ring 400 is inserted into the fixing groove 510 and fixed, in which the roller body 500 is positioned and combined at the center of the central axis 100. That is, one side of the roller body 500 forms an extension integrated with the bushing case. A fixing groove 510 is formed in the other side of the roller body 500. The roller body 500 is fixed by the snap ring 400 provided in the bushing case 300, and thus fixed rotatably with respect to the central axis 100.

The left and right roller bodies 500a and 500b are combined by welding at the state where the roller bodies are brought into contact with each other.

Meanwhile, lubricant paths 520 and 520a are penetrated and formed in an extension of the roller body 500b integrated with the bushing case. The lubricant paths 520 and 520a are formed above and below around the central axis 100 in correspondence to each other. One side path of the lubricant paths 520 and 520a is connected in the space between a central protrude 110 and the roller body 500. The other side path is connected to the lower end of the seals 600 and 600a, respectively. The lubricant paths 520 and 520a are inclined. The two inclined lubricant paths 520 and 520a circulate lubricant oil forcedly into the track roller in depth by rotation of the roller body 500 at the time of an equipment operation.

An assembly method of the present invention will follow in more detail.

First, the bushings 200 and 200a are inserted in both left and right sides of the central protrusion 110 on the central axis 100. Then, an extension in which a bushing case is integrated is formed in the right bushing 200a, and the roller body 500b is inserted on which the two inclined lubricant paths 520 and 520a are formed. When the roller body 500 is fixed, the snap ring 400 is fitted on the outer circumferential surface of the bushing case 300 to be provided in the left side. The bushing case 300 having the snap ring 400 is put into the roller body 500, while letting the bushing case 300 to slide on the left bushing 200. Then, the snap ring 400 moves along the inner circumferential surface of the round-off processed roller body 500 and is compressed. When the snap ring 400 enters into the roller body 500 and reaches the fixing groove 510, the snap ring 400 expands by the elastic force and inserted into the fixing groove 510. Thus, roller body 500 is rotatably fixed on the central axis 100.

As described above, the track roller according to the present invention is formed by integrating the internal bushing case and the roller body, to thereby provide an effect of reducing the number of components. Accordingly, the present invention facilitates an assembly, reduces an assembly time. In particular, as the number of components is reduced, a component failure is reduced and a production cost is saved, to thereby enhance an economical merit. In addition, the integrated components provides an effect of increasing system stability. Further, the other one bushing case need not be controlled during disassembling and assembling, which provides an advantage of facilitating maintenance for repairing and replacing a component.

The track roller forming the two inclined lubricant paths in the roller body functions a forced lubrication due to rotation of the roller body during operation of the equipment to thereby provide an effect of improving a lubricant capability. Also, since the lubricant is provided into the inner portion of the track roller in depth, noise and overheat which occurs owing to abrasion between the components can be prevented, and provides an effect of lengthening a life cycle of the track roller.

What is claimed is:

1. A track roller having a pair of left and right bushings inserted on the central protrusion of a central axis and which is rotatably fixed, the track roller comprising:
a bushing case inserted on an outer circumferential surface of one side of the bushing;
a roller body provided in the outer circumferential surface of the bushing case and formed in a shape corresponding to the bushing, in which an extension is formed on the other side of the bushing and provided in the outer circumferential surface of the bushing; and
a combiner for fixing the bushing case and the roller body so that the bushing case and the roller body are not dismantled from each other.

2. The track roller of claim 1, wherein a lubricant path is formed around the central axis in the extension of the roller body.

3. The track roller of claim 1, wherein the combiner comprises a snap ring interposed on the outer circumferential surface of the bushing case in which a fixing groove is formed on the inner circumferential surface of the roller body corresponding to the snap ring.

4. The track roller of claim 2, wherein one side of the lubricant path is connected with a space between the central protrusion of the central axis and the roller body, and the other side thereof is connected with the lower end of a seal and inclined.
